(19) United States
(12) Patent Application Publication
(10) Pub. No.: US 2013/0151011 A1
(43) Pub. Date: Jun. 13, 2013

(54) SERVER SYSTEM WITH FAN SPEED CONTROL

(71) Applicant: Chih-Chung SHIH, Tu-Cheng (TW)

(72) Inventor: Chih-Chung SHIH, Tu-Cheng (TW)

(73) Assignee: HON HAI PRECISION INDUSTRY CO., LTD., Tu-Cheng (TW)

(21) Appl. No.: 13/337,308

(22) Filed: Dec. 27, 2011

(30) Foreign Application Priority Data
Dec. 13, 2011 (TW) 100145912

(51) Int. Cl. G05B 13/00

(52) U.S. Cl. 700/275

(57) ABSTRACT

A server system includes a server cabinet, servers accommodated in the server cabinet capable of modulating a PWM signal, fan groups coupled to a rear side of the server cabinet, and fan control boards. The fan groups each include and to provide a horizontal airflow to cool several servers. The servers are connected to one fan control boards via a first ground cable, a first tachometer cable, and a first PWM cable, and one fan control board is connected to one of the plurality of fan groups via a second ground cable, a second tachometer cable, a second PWM cable, and a supply voltage cable. The servers modulate a PWM signal and send the PWM signals to the corresponding fan group for controlling a rotation speed of the fans, and the first and second tachometer cable transmits in real-time the rotation speed of the fans back to the several servers.

### BACKGROUND

1. Technical Field

The present disclosure relates to a server system capable of controlling fan rotation speeds of the servers.

2. Description of Related Art

Server systems are commonly used to process and store data or information in networks. The server system includes a server cabinet and a number of servers accommodated in the server cabinet. A number of fans are arranged in the back of the server cabinet for cooling the servers during operation. Although conventional server systems satisfy basic requirements, a new type of server system is still needed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a back view of a server system in accordance with an exemplary embodiment.

FIG. 2 is a block diagram of the server system of FIG. 1.

FIG. 3 is a circuit connection diagram of the server system of FIG. 1.

### DETAILED DESCRIPTION

Embodiments of the present disclosure are now described in detail, with reference to the accompanying drawings.

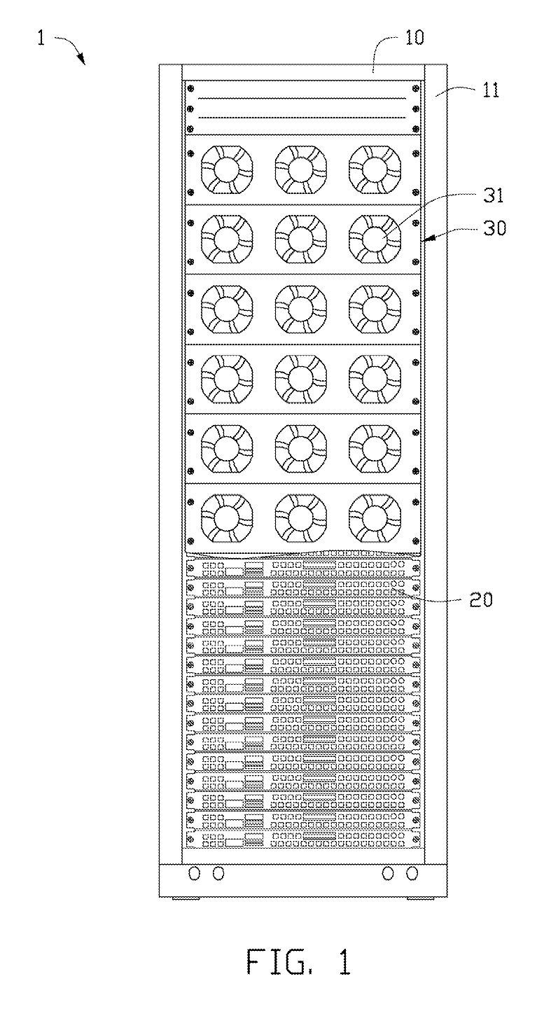

Referring to FIG. 1, a back view of a server system 1 according to an exemplary embodiment is illustrated. The server system 1 includes a rectangular server cabinet 10 with two parallel racks 11, a number of servers 20 located between the two racks 11, and a number of fan groups 30 coupled to a rear side of the server cabinet 10. In the embodiment, the rack 11 is about 42U (1U=44.45 mm) or 48U in height and can accommodate 42 or 48 servers 20 at most.

The fan groups 30 each include a number of parallelly aligned fans 31 to provide a horizontal airflow for cooling the corresponding servers 20. In other embodiments, each fan group 30 may include three, four, or five parallelly aligned fans 31, and the size of each fan 31 is about 92 mm*92 mm or 120 mm*120 mm.

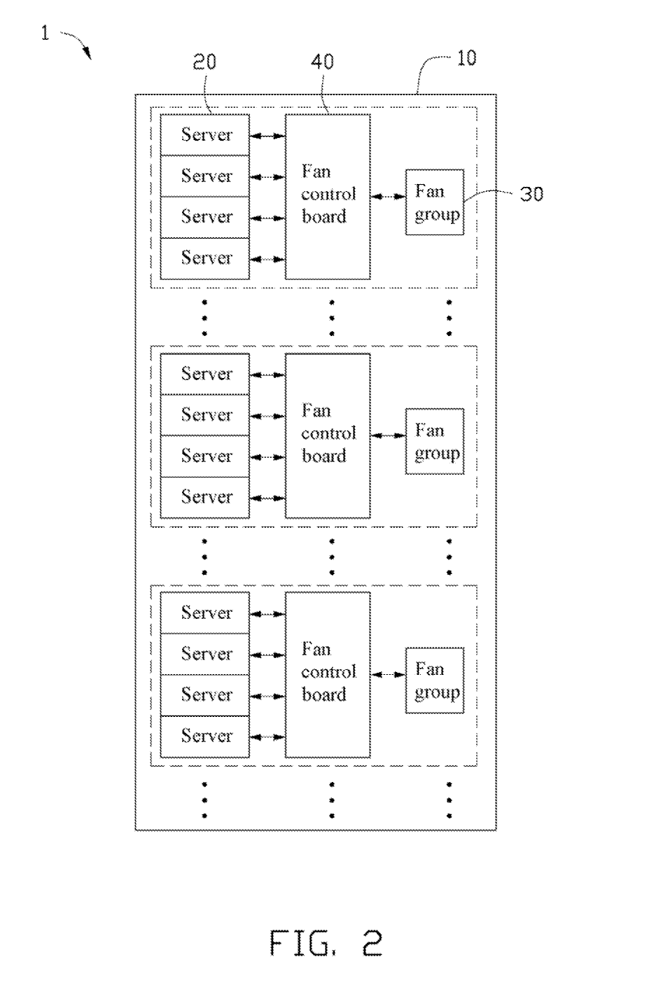

Referring also to FIG. 2, the server system 1 further includes a number of fan control boards 40 connected to the servers 20 and the fans 31 of the fan groups 30. In an exemplary embodiment, the fan control boards 40 can be integrated on a circuit board.

In the embodiment, each control board 40 is connected to one fan group 30 and four servers 20. The fans 31 of the fan group 30 are used to cool the four servers 20.

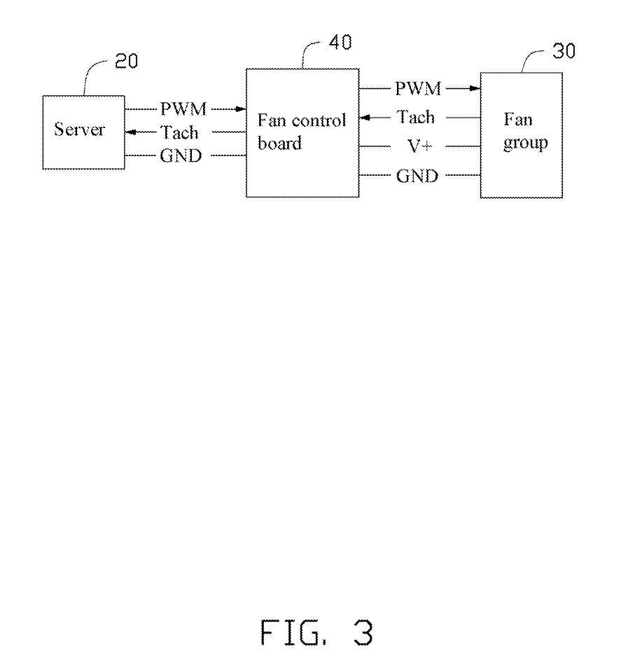

Referring also to FIG. 3, each of the four servers 20 is connected to the corresponding fan control board 40 via a ground (GND) cable, a tachometer (TACH) cable, and a pulse width modulation (PWM) cable. The fan control board 40 is connected to the corresponding fan groups 30 via a GND cable, a TACH cable, a PWM cable, and a supply voltage (V+) cable.

Each of the four servers 20 modulates a PWM signal and sends the PWM signal to the corresponding fan control board 40. The fan control board 40 integrates the PWM signals from the four servers 20 into one PWM signal, and sends the integrated PWM signal to the fan group 30 for controlling a rotation speed of the fans 31. The TACH cable transmits in real-time the rotation speed of the fans 31 back to the servers 20. In the embodiment, the integrated PWM signal is a PWM signal sent from the servers 20 that are associated with a maximum speed. Thus, the fans 31 of the fan groups 30 rotate at a maximum speed to satisfy heat dissipation needs of the servers 20 and can be directly controlled by the servers 20.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A server system comprising:
a server cabinet;
a plurality of servers accommodated in the server cabinet capable of modulating a PWM signal;
a plurality of fan groups coupled to a rear side of the server cabinet, each fan group comprising a plurality of fans to provide a horizontal airflow to cool several of the plurality of servers; and
a plurality of fan control boards, wherein each of the plurality of servers is connected to one of the plurality of fan control boards via a first ground cable, a first tachometer cable, and a first PWM cable, and each one of the plurality of fan control boards is connected to one of the plurality of fan groups via a second ground cable, a second tachometer cable, a second PWM cable, and a supply voltage cable,
wherein the several of the plurality of servers modulate a PWM signal and send the PWM signals to the corresponding fan control board, the fan control board integrates the PWM signals from the several servers into one PWM signal and sends the integrated PWM signal to the corresponding fan group for controlling a rotation speed of the fans, and the first and second tachometer cable transmits in real-time the rotation speed of the fans back to the several servers.

2. The sever system as described in claim 1, wherein the server cabinet comprises two parallel racks, and the plurality of servers are located between the two racks.

3. The sever system as described in claim 2, wherein the racks is about 42U in height and is able to accommodate 42 servers.

4. The sever system as described in claim 2, wherein the racks is about 48U in height and is able to accommodate 48 servers.

5. The sever system as described in claim 1, wherein each fan group comprises three, four, or five parallelly aligned fans.

6. The sever system as described in claim 5, wherein the size of each fan is 92 mm*92 mm.

7. The sever system as described in claim 5, wherein the size of each fan is 120 mm*120 mm.

8. The sever system as described in claim 1, wherein the plurality of fan control boards are integrated on a circuit board.

9. The sever system as described in claim 1, wherein the integrated PWM signal is a PWM signal sent from the servers that are associated with a maximum speed
